(19) United States
(12) Patent Application Publication
(10) Pub. No.: US 2007/0011323 A1
(43) Pub. Date: Jan. 11, 2007

(54) Anti-spam system and method

(75) Inventor: Tamas Gaal, Grenoble (FR)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/172,822

(22) Filed: Jul. 5, 2005

(51) Int. Cl. G06F 15/16

(52) U.S. Cl. 709/225

(57) ABSTRACT

In a system, in which there is provided a cleartext blacklist (that defines a set of strings identifying keywords of unsolicited messages), a filler grammar (that identifies characters or symbols for distorting elements of strings in the cleartext blacklist with filler space), and a transcription grammar (that identifies characters or symbols for distorting elements of strings in the cleartext blacklist with similes), the following are produced: an anti-spam grammar (by merging the filler-grammar and the transcription-grammar), an abstract-text blacklist (by applying the anti-spam grammar to the cleartext blacklist), and an anti-spam automaton (using the cleartext blacklist and the abstract-text blacklist). The anti-spam automaton may be adapted to recognize an input string in the cleartext blacklist from its disguised form in the abstract-text blacklist.

### BACKGROUND AND SUMMARY

The following relates generally to methods, apparatus and articles of manufacture therefor, for using finite state networks to detect unsolicited message content.

Given the availability and prevalence of various technologies for transmitting electronic message content, consumers and businesses are receiving a flood of unsolicited electronic messages. These messages may be in the form of email, SMS, instant messaging, voice mail, and facsimiles. As the cost of electronic transmission is nominal and email addresses and facsimile numbers relatively easy to accumulate (for example, by randomly attempting or identifying published email addresses or phone numbers), consumers and businesses become the target of unsolicited broadcasts of advertising by, for example, direct marketers promoting products or services. Such unsolicited electronic transmissions sent against the knowledge or interest of the recipient is known as “spam”.

There exist different methods for detecting whether an electronic message such as an email or a facsimile is spam. For example, the following U.S. Patent Nos. describe systems that may be used for filtering facsimile messages: U.S. Pat. Nos. 5,168,376; 5,220,599; 5,274,467; 5,293,253; 5,307,178; 5,349,447; 4,386,303; 5,508,819; 4,963,340; and 6,239,881. In addition, the following U.S. Patent Nos. describe systems that may be used for filtering email messages: U.S. Pat. Nos. 6,161,130; 6,701,347; 6,654,787; 6,421,709; 6,330,590; and 6,324,569.

Generally, these existing systems rely on either feature-based methods or content based methods. Features based methods filter based on some characteristic(s) of the incoming email or facsimile. These characteristics are either obtained from the transmission protocol or extracted from the message itself. Once the characteristics are obtained, the incoming message may be filtered on the basis of a whitelist (i.e., acceptable sender list or a non-spammer list), a blacklist (i.e., unacceptable sender list or spammer list) or a combination of both. Content based methods may be pattern matching techniques, or alternatively may involve categorization of message content (using for example a Naïve Bayes categorizer). In addition, these methods may require some user-intervention, which may consist of letting the user finally decide whether or not a message is spam.

A commonly used technique by spammers to avoid detection of cleartext message content is to disguise sensitive keywords in the message that may alert content-based anti-spam detection systems of the possibility of a message being spam. For example, such disguises may involve the insertion of perceptibly-neutral letters in a human-understandable string (e.g., “dr_ug”) or perceptibly-similar letters in a human-understandable string (e.g., “drvg”). It would therefore be desirable to provide a system that is adapted to identify different combinations of sensitive keywords that may be disguised using either perceptibly similar or neutral letters. It would be advantageous if such a system were modular and therefore readily maintained when a keyword or disguise is added or removed.

In accordance with the various embodiments disclosed herein, there is provided a method, apparatus and article of manufacture therefor, for addressing these and other problems, by: receiving a cleartext blacklist that defines a set of strings (identifying keywords of unsolicited messages); receiving a filler grammar that identifies characters or symbols for distorting elements of strings in the cleartext blacklist with filler space; receiving a transcription grammar that identifies characters or symbols for distorting elements of strings in the cleartext blacklist with similes; producing an anti-spam grammar by merging the filler-grammar and the transcription-grammar; producing an abstract-text blacklist by applying the anti-spam grammar to the cleartext blacklist; producing an anti-spam automaton, using the cleartext blacklist and the abstract-text blacklist, for recognizing an input string in the cleartext blacklist from its disguised form in the abstract-text blacklist.

Advantageously over ad hoc solutions (e.g., by adding, case by case, to an exception dictionary and then using standard software methods to perform string comparison and/or replacement), the various embodiment described herein are adaptive and not error-prone.

### BRIEF DESCRIPTION OF THE DRAWINGS

These and other aspects of the disclosure will become apparent from the following description read in conjunction with the accompanying drawings wherein the same reference numerals have been applied to like parts and in which:

FIG. 1 illustrates a system and operations therefor of an embodiment for generating an automaton for detecting disguised or camouflaged spam words using finite state technology;

FIG. 2 illustrates an example abstract text black-listed string of the cleartext string “vi” in the form of an automaton;

FIG. 3 illustrates an example single-word transducer that accepts a quasi-unlimited number of abstract text blacklist forms of the cleartext blacklisted string “vi”;

FIG. 4 illustrates a system for applying multi-word anti-spam automatons developed using the system in FIG. 1.

### DETAILED DESCRIPTION

A. Conventions and Definitions

Finite-state automata are considered to be networks, or directed graphs that are represented in the figures using directed graphs that consist of states and labeled arcs. The finite-state networks in the figures contain one initial state (but could contain more than one), also called the start state, and one or more final states. In the figures, states are represented as circles and arcs are represented as arrows. Also in the figures, the start state is always the leftmost state and final states are marked by a double circle (one of which may be the start state).

Each state in a finite-state network acts as the origin for zero or more arcs leading to some destination state. A sequence of arcs leading from the initial state to a final state is called a “path”. A “subpath” is a sequence of arcs that does not necessarily begin at the initial state or end at a final state. An arc may be labeled either by a single symbol such as “a” or a symbol pair such as “a:b” (i.e., two-sided symbol), where “a” designates the symbol on the upper side of the arc and “b” the symbol on the lower side. If all the arcs are labeled by a single symbol, the network is a single-tape automaton; if at least one label is a symbol pair, the network is a transducer or a two-tape automaton; and more generally, if the arcs are labeled by “n” symbols, the network is an n-tape automaton.

Further background on finite-state technology is set forth in the following references, which are incorporated herein by reference: Lauri Karttunen, “Finite-State Technology”, Chapter 18, The Oxford Handbook of Computational Linguistics, Edited By Ruslan Mitkov, Oxford University Press, 2003; Kenneth R. Beesley and Lauri Karttunen, “Finite State Morphology”, CSLI Publications, Palo Alto, Calif., 2003; Lauri Karttunen, “The Replace Operator”, Proceedings of the 33rd Annual Meeting of the Association for Computational Linguistics, Boston, Mass., pp. 16-23, 1995; U.S. Pat. No. 6,023,760, entitled “Modifying An Input String Partitioned In Accordance With Directionality And Length Constraints”.

The table that follows sets forth definitions of terminology used throughout the specification, including the claims and the figures. Other terms are explained at their first occurrence.

| Term | Definition |
|---|---|
| Spam | Unsolicited transmissions sent against |
| | the knowledge of the recipient. |
| String, Language, | A string is concatenation of symbols, |
| and Relation | that may, for example, define a word or |
| | a phrase. The symbols may encode, for |
| | example, alphanumeric characters (e.g., |
| | alphabetic letters), music notes, |
| | chemical formulations, biological |
| | formulations, and kanji characters (e.g., |
| | which symbols in one embodiment may be |
| | encoded using the Unicode character set). |
| | A language refers to a set of strings. |
| | A relation refers to a set of ordered |
| | pairs, such as {<a, bb>, <cd, ε>}. |
| Union Operator “\|” | Constructs a regular language that includes |
| | all the strings of the component languages. |
| | For example, “a \| b” denotes the |
| | language that contains the strings “a” |
| | and “b”, but not “ab”. |
| Escape Character “%” | Eliminates any special meaning of the |
| | following character. For example, “%0” |
| | represents the string “0” rather than |
| | the epsilon symbol; “%\|” is the |
| | vertical bar itself, as opposed to the |
| | union operator “\|”. The ordinary |
| | percent sign may be expressed as %%. |
| Kleene Plus “+” | The language or relation A concatenated |
| | with itself any number of times, |
| | including zero times. A+ includes |
| | [A], [A A], [A A A], and |
| | so on ad infinitum. “?+” is |
| | the language of all nonempty strings. |
| Kleene Star “*” | The union of A+ with the empty-string |
| | language. A* is equivalent to (A+). |
| | ?* denotes the universal language. |
| “Define” Function | The variable “v” may be defined as |
| | the language of the possible values. For |
| | example, “define color [blue \| green \| |
| | red \| white \| yellow]”, defines the |
| | language “color” with the possible |
| | values blue, red, white, and yellow. |
| A −> B | Replacement of the language A by the |
| | language B. This denotes a relation that |
| | consists of pairs of strings that are |
| | identical except that every instance of |
| | A in the upper-side string corresponds |
| | to an instance of B in the lower-side |
| | string. For example, [a −> b] |
| | pairs “b” with “b” (no |
| | change) and “aba” with “bbb” |
| | (replacing both “a”s by “b”s). |
| A @−> B | Left-to-right, longest match replacement |
| | of the language A by the language B. |
| | Similar to [A −> B] except that |
| | the instances of A in the upper-side |
| | string are replaced selectively, starting |
| | from the left, choosing the longest |
| | candidate string at each point. |
| ε (i.e., epsilon) | Denotes the symbol for an empty string. |
| ? | Denotes the unknown symbol. |

B. Generating an Anti-Spam Automaton

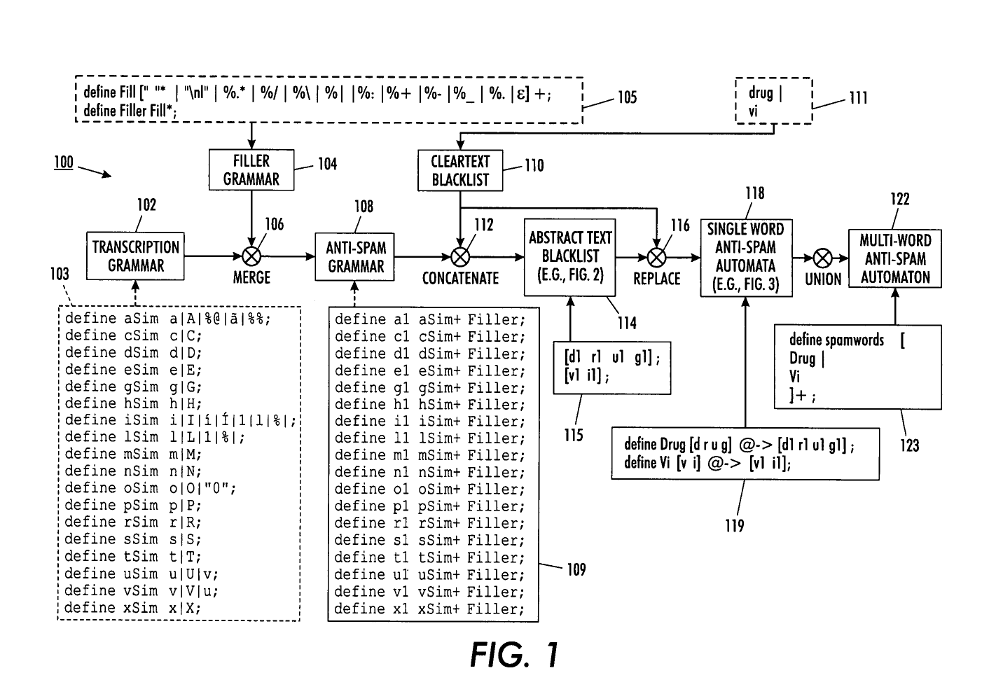

FIG. 1 illustrates a system 100 and operations therefor of an embodiment for generating an automaton for detecting disguised or camouflaged spam words using finite state technology. The system 100 is initialized by defining a finite state language model of distortions to a cleartext (i.e., plaintext) blacklist 110. In one embodiment, the cleartext blacklist 110 defines a set of strings that identify keywords forming part of unsolicited messages, see for example the cleartext blacklist 111 that specifies the words “drug” and “vi”. Such keywords may comprise words, logos, symbols, trademarks, expressions, or phrases, which have a defined meaning beyond the characters and symbols that are used to represent them. In an alternate embodiment, keywords defined in the cleartext blacklist may comprise all or portions of a language dictionary.

In defining the finite state language model a filler grammar 104, such as grammar 105, and a transcription grammar 102, such as grammar 103, are defined. The hypothesis of the finite state language module is that a spam-word may be disguised by either introducing filler-space (i.e., white space or quasi-white-space as “—” or “_”) or by the replacement of simile characters, or by both.

The filler grammar 104 defines characters (e.g., spaces) or symbols (e.g., the underscore character), or combinations thereof, that may be used for distorting cleartext with filler space between elements of strings in the cleartext blacklist 110. For example, the filler grammar 104 may be used to define “white spaces” or quasi-white-space as “—” or “_”, or both, which can be interjected without changing the meaning while disguising its appearance (e.g., the cleartext string “selling” may be disguised by introducing spaces and underscore characters as: “s e_l−l+i______ng” yet remaining readably understandable).

The transcription grammar 102 defines characters or symbols, or combinations thereof, that may be used for distorting cleartext with similes (i.e., elements, such as characters or symbols, that closely resemble another element in meaning or appearance). For example, similes of characters may specify different forms a character may take together with their substitutes, alternate representations, symbolic representations, or look-alikes (e.g., for the character “a” similes may include “@”, “ˆ”, or “ a̅”, and for the character “u” a simile may include “v”).

In one embodiment, the filler grammar 104 and the transcription grammar 105 are defined with regular expression formalisms using an appropriate finite state authoring tool, such as XFST (available with the publication Kenneth R. Beesley and Lauri Karttunen, “Finite State Morphology”, CSLI Publications, Palo Alto, Calif., 2003), as illustrated at 105 and 103, respectively. XFST permits the definition using replacement rules and the “any” symbol (or equivalent, i.e., a symbol that represents any symbol that occurs in the same regular expression and any unknown symbol) and the subsequent transformation of regular expressions to a finite state transducer.

More specifically, similes may be defined in a transcription grammar at 102 with an appropriate regular expression, as shown for example at 103, using an XFST code fragment that defines an identifier (e.g., “aa”) to represent a character in the alphabet, as well as, its disguises (e.g., “a”, or “A”, or “@”, or “ˆ” etc.), which definition may be performed for all letters of the alphabet or a sub-set of letters that occur only in the strings listed in the cleartext blacklist. Further, possible white-spaces or quasi-white-spaces are defined in a filler grammar at 104, as shown for example at 105, by defining a “filler” automaton, which defines a set of filler characters or symbols that may appear zero or more times (where an upper limit and interval may also possibly be defined) using the union, Kleene star, and Kleene plus XFST operations.

Module 106 performs a merge operation on the transcription grammar 102 and filler grammar 104 to produce anti-spam grammar 108. More specifically, the module 106 combines the filler and transcription grammar into new composed characters or symbols (i.e., spam characters or symbols) in the anti-spam grammar 108, as shown for example at 109, that describe possible alterations of a character or symbol to a spam pattern which may be recognized as a representation of its blacklist form (e.g., “a” into, for example, “+-@______”), using the union and Kleene plus XFST operations. More specifically, in the example shown at 109, abstract text characters are defined as “a1”, “b1”, “c1”, etc. to correspond to cleartext characters “a”, “b”, “c”, etc., respectively. It will be appreciated that the notation used for defining a one-to-one mapping between abstract text characters and its cleartext equivalent need not be limited to “#1” notation (i.e., where “#” signifies the cleartext character), and may alternatively be defined using any number of notations (e.g., “#-abstract”).

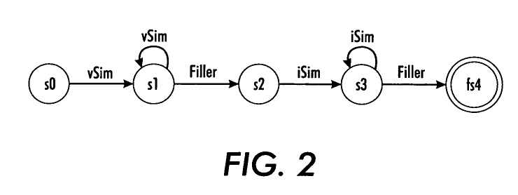

Module 112 produces using concatenation an abstract text blacklist 114 that is made up of one or more strings, which in one embodiment may be represented using an automaton. Each string of the abstract text blacklist 114 is produced by replacing its cleartext characters, defined in the cleartext blacklist 110, with abstract text characters, defined in the anti-spam grammar 108. That is at 112, each cleartext string 111 is mapped (and transcribed) to its abstract text equivalent, as shown for example at 115 where each cleartext-string character like “v” and “i” is matched to its corresponding abstract text string “v1” and “i1”, respectively (e.g., where the characters of the string “v i” have been mapped to “v1 i1”). This mapping operation may, for example, be performed using a PERL script, an AWK program, or an equivalent. This mapping may subsequently be represented, in one embodiment, using an automaton. FIG. 2 illustrates an example abstract text black-listed string of the cleartext string “vi” in the form of an automaton.

Subsequently after mapping each cleartext string to its abstract text equivalent, single-word anti-spam automata 118 may be produced by module 116 (e.g., using the XFST replace operation) that takes as input strings in the abstract text blacklist 114 and strings in the clear text blacklist 110, as shown for example at 119, using an XFST code fragment for defining an automaton for the cleartext string “drug” having abstract text string [d1, r1, u1, g1] and for the cleartext string “vi” having abstract text string [v1, i1].

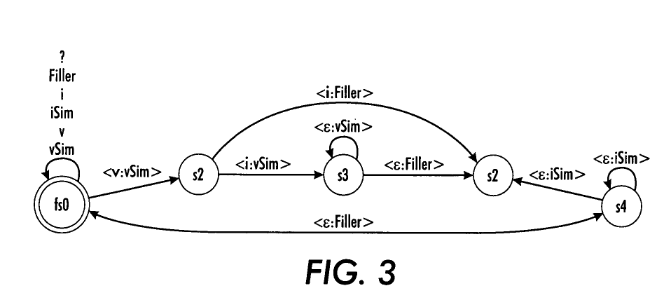

FIG. 3 illustrates an example single-word transducer (or two-tape automaton) that accepts a quasi-unlimited number of abstract text blacklist forms of the cleartext blacklisted string “vi” on the lower side of the automaton (e.g., “vSim” of <v:vSim>), where the different abstract forms are defined by the transcription grammar 102 and the filler grammar 104, and returns its cleartext blacklisted form if a match occurs on the upper side of the automaton (e.g., “v” of <v:vSim>). Those skilled in the art will appreciate that the transducer shown in FIG. 2 is non-deterministic (i.e., will provide more than one solution), and a unique solution may be identified by matching the solutions it produces against strings in the cleartext blacklist 110, which matching string will be the unique solution. The returned form may be any number of forms such as its original cleartext blacklisted form (e.g., define Vi vi@->[v1 i1]]) or a marked up form (e.g., define Vi [[“<SPAM_HERE>” {vi} “<SPAM_HERE>”] @->[v1 i1]]), using for example XML tags or another form of markers.

Module 120 combines the single-word anti-spam automata 118 into a multi-word anti-spam automaton 122 (e.g., using the XFST union and kleene plus operations). As shown for example at 123, an XFST code fragment assembles a dictionary of two abstract text blacklisted words into a finite state automaton 122. The resulting multi-word anti-spam automaton 122 is adapted to identify text parts that correspond to words defined in the cleartext blacklist 110 which have been distorted according to the language model defined by anti-spam grammar 108. Once a distortion is identified, the automaton 122, depending on the replace operation defined, may be used to transform any distorted word to any number of different forms, such as, its non-distorted form or a tagged non-distorted form, or vice versa.

In one embodiment, the finite state automaton 122 may be an automaton that is a transducer where on one side of the transducer there is a plurality (or quasi-infinite number) of camouflaged spam words generated using the abstract text blacklist 114 which are mentally synthesizable by a literate human observer and on the other side of the transducer there are spam words from the cleartext blacklist 110. In another embodiment, the automaton is a multi-tape with one or more weighted transitions that may be used, for example, to account for misspellings or alternate spellings of strings in the cleartext blacklist 110.

One advantage of the anti-spam embodiments described herein is that while it is easy to develop substitutes for masking a string that is on the cleartext blacklist 110, it is unlikely that a combination of strings that are not spam would result in a “false positive” match using the multi-word automaton 122. A further advantage of the anti-spam embodiment is the modularity of the system 100 that permits the filler grammar 104, the transcription grammars 102, and cleartext blacklist 110 to be updated independent from each other, yet be taken into account when merged at 106 or concatenated at 112. Such modularity may be further exploited by defining one or more cleartext blacklists that are domain (or subject matter) specific that may be subsequently merged into a general cleartext blacklist 110. Those skilled in the art will appreciate that script files may be used for automating the production of the multi-word anti-spam automaton 122 once either one or more of the filler grammar 104, the transcription grammars 102, and cleartext blacklist 110 have been changed.

C. Using the Anti-Spam Automaton

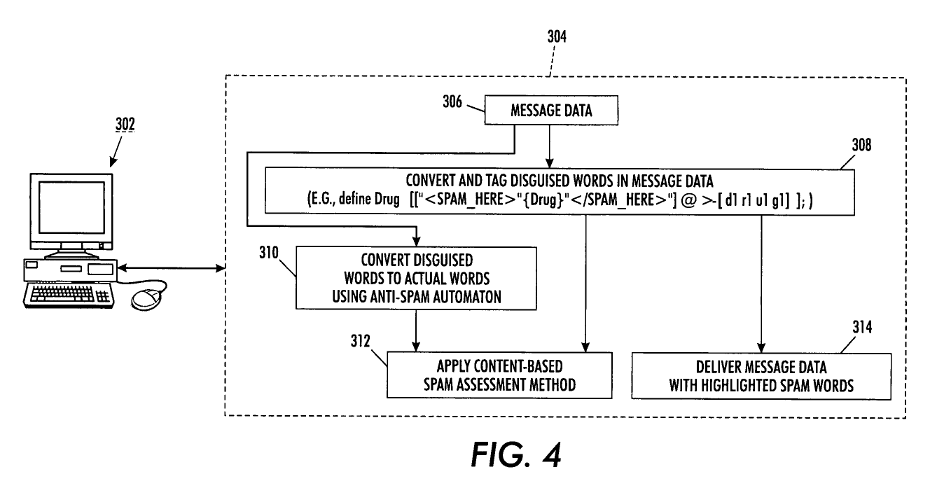

FIG. 4 illustrates a computer system 302 with processing instructions in memory 304 for applying the multi-word anti-spam automaton 122 developed using the system 100 in FIG. 1, which may also form part of the system 302. In operation on its own or in combination with other applications, the anti-spam automaton 122 is used for processing message data 306. The message data 306 may be any form of textual content, or image content from which textual content is extracted, for example, using an OCR (Optical Character Recognition) system. The message data 306 may arrive from a number of sources, such as, message data received via email, facsimile, browser download, file transfer, or otherwise.

By way of overview, the message data 306 is submitted to the automaton 122 where the text is scrutinized for the possible presence of disguised strings in the abstract text blacklist 114. In one embodiment at 310, when the automaton 122 recognizes in the message data 306 a string in the cleartext blacklist 110, its abstract-text blacklist form in the message data 306 is replaced with its cleartext blacklist form (i.e., undisguised form). Once strings in the message data 306 that are identified in the abstract text blacklist 114 and replaced with strings from the cleartext blacklist 110 (e.g., dr_vg is replaced by drug in the message data), the modified message data may be output to, for example, a content based spam assessment method at 312 or an alternate routing and/or classification system as discussed in more detail herein.

In an alternate embodiment at 308, when the automaton 122 recognizes in the message data 306 a string in the cleartext blacklist 110, its abstract-text blacklist form in the message data 306 is replaced with a tagged cleantext representation (e.g., dr_vg may be replaced by <spam>drug</spam> in the message data). Once strings in the message data 306 that are identified in the abstract text blacklist 114 and replaced with tagged strings from the cleartext blacklist 110, the modified message data may be output either directly to the user at 314, or alternatively, they may be applied to a content based spam assessment method at 312 or an alternate routing and/or classification system as discussed in more detail herein.

In either embodiment at 308 or 310, if the automaton 122 does not identify any strings in the message data 306 with an abstract-text blacklist form, no action is taken and the message data 306 is unchanged. In yet another embodiment once strings that are in the cleartext blacklist are identified and corrected in the message data 306, a series or cascade of automatons may be used to perform one or more of a combination of additional or alternate operations at 312.

More generally, the message data 306 (i.e., an input string) may be evaluated for spam-suspicious message content (i.e., abstract-text fragments) by executing a lookup finite state operation with the multi-word anti-spam automaton 122 that is used to identify patterns defined using the abstract text blacklist 114. If a match is found between an abstract-text fragment and the abstract text blacklist 114, the finite state operation may be adapted to reproduce the message data 306 while changing strings disguised in abstract-text form (i.e., abstract-text fragments) to their cleartext form or a tagged cleartext form, which changed message data may subsequently be output (e.g., routed and/or classified depending on its content or output to a user) or further processed by one or more additional operations. In one embodiment, changed message data is output to a content based anti-spam system, as for example described in U.S. patent application Ser. No. 11/002,179, entitled “Adaptive Spam Message Detector”, which is incorporated herein by reference in its entirety. In another embodiment, changed message data may subsequently be labeled or classified as spam, or alternatively used for specifying one or more attributes of the message data 306 that are subsequently used to assess the overall probability of the message data being spam.

D. Miscellaneous

It will be appreciated by those skilled in the art that as two-tape automatons (or transducers) are bidirectional in nature, the multi-word anti-spam automaton (or transducer) may be used to produce possible disguises for a set of words. The disguised words may be provided to a spam detection system that relies on an exception dictionary to augment its list of exceptions.

Those skilled in the art will also recognize that a general purpose computer may be used as an apparatus for implementing the anti-spam system shown in FIGS. 1 and 4 and described herein. Such a general purpose computer would include hardware and software. The hardware would comprise, for example, memory (ROM, RAM, etc.) (e.g., for storing networks and processing instructions of the anti-spam system), a processor (i.e., CPU) (e.g., coupled to the memory for executing the processing instructions of the anti-spam system), persistent storage (e.g., CD-ROM, hard drive, floppy drive, tape drive, etc.), user I/O, and network I/O. The user I/O may include a camera, a microphone, speakers, a keyboard, a pointing device (e.g., pointing stick, mouse, etc.), and the display. The network I/O may for example be coupled to a network such as the Internet. The software of the general purpose computer would include an operating system and application software providing the functions of the anti-spam system.

Further, those skilled in the art will recognize that the forgoing embodiments may be implemented as a machine (or system), process (or method), or article of manufacture by using standard programming and/or engineering techniques to produce programming software, firmware, hardware, or any combination thereof. It will be appreciated by those skilled in the art that the flow diagrams described in the specification are meant to provide an understanding of different possible embodiments. As such, alternative ordering of the steps, performing one or more steps in parallel, and/or performing additional or fewer steps may be done in alternative embodiments.

Any resulting program(s), having computer-readable program code, may be embodied within one or more computer-usable media such as memory devices or transmitting devices, thereby making a computer program product or article of manufacture according to the embodiment described herein. As such, the terms “article of manufacture” and “computer program product” as used herein are intended to encompass a computer program existent (permanently, temporarily, or transitorily) on any computer-usable medium such as on any memory device or in any transmitting device.

Executing program code directly from one medium, storing program code onto a medium, copying the code from one medium to another medium, transmitting the code using a transmitting device, or other equivalent acts may involve the use of a memory or transmitting device which only embodies program code transitorily as a preliminary or final step in making, using, or selling the embodiments as set forth in the claims.

Memory devices include, but are not limited to, fixed (hard) disk drives, floppy disks (or diskettes), optical disks, magnetic tape, semiconductor memories such as RAM, ROM, Proms, etc. Transmitting devices include, but are not limited to, the Internet, intranets, electronic bulletin board and message/note exchanges, telephone/modem based network communication, hard-wired/cabled communication network, cellular communication, radio wave communication, satellite communication, and other stationary or mobile network systems/communication links.

A machine embodying the embodiments may involve one or more processing systems including, but not limited to, CPU, memory/storage devices, communication links, communication/transmitting devices, servers, I/O devices, or any subcomponents or individual parts of one or more processing systems, including software, firmware, hardware, or any combination or subcombination thereof, which embody the disclosure as set forth in the claims.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A method, comprising:
receiving a cleartext blacklist that defines a set of strings;
receiving a filler grammar that identifies characters or symbols for distorting elements of strings in the cleartext blacklist with filler space;
receiving a transcription grammar that identifies characters or symbols for distorting elements of strings in the cleartext blacklist with similes;
producing an anti-spam grammar by merging the filler-grammar and the transcription-grammar;
producing an abstract-text blacklist by applying the anti-spam grammar to the cleartext blacklist;
producing an anti-spam automaton, using the cleartext blacklist and the abstract-text blacklist, for recognizing an input string in the cleartext blacklist from its disguised form in the abstract-text blacklist.

2. The method according to claim 1, further comprising applying the anti-spam automaton to the input string to identify whether one or more abstract-text fragments in the input string match one or more strings from the abstract-text blacklist.

3. The method according to claim 2, further comprising applying one or more content-based spam assessment methods to the input string after applying the anti-spam automaton.

4. The method according to claim 2, wherein said applying applies the anti-spam automaton to the input string to replace one or more abstract-text fragments in the input string with their matching strings from the cleartext blacklist.

5. The method according to claim 4, wherein said applying tags the one or more abstract-text fragments replaced with their matching strings from the cleartext blacklist with markers.

6. The method according to claim 1, wherein the anti-spam automaton is a multi-tape automaton.

7. The method according to claim 1, further comprising applying anti-spam automaton to a string in the cleartext blacklist to produce disguised forms thereof in the abstract-text blacklist.

8. The method according to claim 1, further comprising updating elements forming part of one or more of the cleartext blacklist, the filler-grammar, and the transcription-grammar.

9. The method according to claim 1, wherein the anti-spam grammar is produced by concatenating the filler-grammar and the transcription grammar.

10. The method according to claim 1, wherein the anti-spam automaton is produced by:
producing a plurality of single string automata for each string in the cleartext blacklist;
producing the anti-spam automaton by computing a union of the plurality of single string automata.

11. An apparatus, comprising:
a memory for storing processing instructions of the apparatus; and
a processor coupled to the memory for executing the processing instructions of the apparatus; the processor in executing the processing instructions:
receiving a cleartext blacklist that defines a set of strings;
receiving a filler grammar that identifies characters or symbols for distorting elements of strings in the cleartext blacklist with filler space;
receiving a transcription grammar that identifies characters or symbols for distorting elements of strings in the cleartext blacklist with similes;
producing an anti-spam grammar by merging the filler-grammar and the transcription-grammar;
producing an abstract-text blacklist by applying the anti-spam grammar to the cleartext blacklist;
producing an anti-spam automaton, using the cleartext blacklist and the abstract-text blacklist, for recognizing an input string in the cleartext blacklist from its disguised form in the abstract-text blacklist.

12. The apparatus according to claim 11, wherein the processor in executing the processing instructions further comprises applying the anti-spam automaton to the input string to identify whether one or more abstract-text fragments in the input string match strings from the abstract-text blacklist.

13. The apparatus according to claim 12, wherein the processor in executing the processing instructions further comprises applying one or more content-based spam assessment methods to the input string after applying the anti-spam automaton.

14. The apparatus according to claim 12, wherein the processor in executing the processing instructions applies the anti-spam automaton to the input string to replace one or more abstract-text fragments in the input string with their matching strings from the cleartext blacklist.

15. The apparatus according to claim 14, wherein the processor in executing the processing instructions tags the one or more abstract-text fragments replaced with their matching strings from the cleartext blacklist with markers.

16. The apparatus according to claim 11, wherein the anti-spam automaton is a multi-tape automaton.

17. The apparatus according to claim 11, wherein the processor in executing the processing instructions further comprises applying the anti-spam automaton to a string in the cleartext blacklist to produce disguised forms thereof in the abstract-text blacklist.

18. The apparatus according to claim 11, wherein the processor in executing the processing instructions further comprises updating elements forming part of one or more of the cleartext blacklist, the filler-grammar, and the transcription-grammar.

19. The apparatus according to claim 11, wherein the processor in executing the processing instructions further comprises producing the anti-spam automaton by concatenating the filler-grammar and the transcription grammar.

20. The apparatus according to claim 11, wherein the processor in executing the processing instructions further comprises producing the anti-spam automaton by:
producing a plurality of single string automata for each string in the cleartext blacklist;
producing the anti-spam automaton by computing a union of the plurality of single string automata.
